(19) United States
(12) Patent Application Publication
(10) Pub. No.: US 2024/0004575 A1
(43) Pub. Date: Jan. 4, 2024

(54) STORAGE SYSTEM AND DATA MANAGEMENT METHOD OF STORAGE SYSTEM

(71) Applicant: Hitachi, Ltd., Tokyo (JP)

(72) Inventors: Yu Yoshizawa, Tokyo (JP); Hirotaka Nakagawa, Tokyo (JP)

(73) Assignee: Hitachi, Ltd., Tokyo (JP)

(21) Appl. No.: 18/181,095

(22) Filed: Mar. 9, 2023

(30) Foreign Application Priority Data
Jul. 4, 2022 (JP) 2022-108051

(51) Int. Cl. G06F 3/06

(52) U.S. Cl. CPC G06F 3/0655; G06F 3/0604; G06F 3/067

(57) ABSTRACT

A storage system prevents the destruction of data stored in logical volumes when the same ID for logical volumes is assigned to a plurality of logical volumes. The storage system stores virtual ID management information including, the virtual ID, a storage device ID identifying the storage device including the logical volume assigned to the virtual ID, and usage permission information indicating whether to permit assigning the virtual ID to the logical volume and using the logical volume. The storage system does not execute the logical volume usage processing which uses the usage target logical volume, when the storage system determines not to permit using the logical volume based on a usage target virtual ID assigned to the usage target logical volume which is target of use, the usage target storage device ID of the usage target storage device including the usage target logical volume, and virtual ID management information.

### BACKGROUND OF THE INVENTION

### 1. Field of the Invention

The present invention relates to a storage system including a plurality of storage devices connected to a host computer, wherein a logical volume for storing information is created in each of the storage devices, a virtual ID for identifying the logical volume is assigned to the logical volume, and the virtual ID is used to identify the logical volume to be accessed by the host computer, and a data management method of the storage system.

### 2. Description of the Related Art

A system in which a host computer stores data in each of a plurality of storage devices in a virtual environment, is used. Here, logical volumes, which are storage areas for storing information, are created in the storage device. In addition, the logical volume is assigned a virtual ID that identifies the logical volume. The host computer identifies the logical volume by the virtual ID.

In the virtual environment, the administrator of a storage device often assigns a virtual ID to a logical volume when creating the logical volume. Then, the same virtual ID can be assigned to different logical volumes in each of two storage devices. If the same virtual ID is assigned to each of a plurality of logical volumes storing different data, the plurality of logical volumes storing different data may be accessed without distinction, and the data stored in the logical volumes may be destroyed.

Therefore, there are technologies for suppressing destruction of the data stored in logical volumes. For example, in JP 2007-286946 discloses a technology for suppressing the destruction of data in two logical volumes that are synchronized with each other. In the technology disclosed in JP 2007-286946 A, when a host computer rewrites the data of one logical volume to be the latest data, the host computer is accessible only to one logical volume storing the latest data, and stops the access to the other logical volume, until the data of the data in the two logical volumes match in synchronization. Accordingly, it is possible to suppress the destruction of data stored in the logical volume that is being synchronized.

### SUMMARY OF THE INVENTION

However, even if the technology related to the logical volumes being synchronized disclosed in JP 2007-286946 A, when the logical volume is not synchronized, such data destruction cannot be suppressed.

In addition, the storage devices can be placed in a variety of locations. For example, there are cases where storage devices are arranged over a wide area, such as a case where storage devices are arranged in each of a plurality of countries. In addition, there are cases where a host computer may create and use new logical volumes not only in the storage device used by the host computer but also in the storage device used by other host computers. In particular, in these cases, the same ID for identifying the logical volume can be assigned to each of a plurality of logical volumes in which different data is stored, which may destroy the data stored in the logical volume.

Therefore, an object of the invention is to provide a storage system and data management method of storage system, that prevent the destruction of data stored in logical volumes that occurs when the same ID for identifying the logical volumes is assigned to each of a plurality of logical volumes in which different data are stored.

In order to attain the object described above, one aspect of a storage system of the invention is a storage device ID of the usage target storage device including the usage target logical volume, when a logical volume identifying information for identifying a usage target logical volume which is target of use is input, and to determine whether to permit assigning the virtual ID to the logical volume and using the logical volume, based on consistency with the virtual ID management information, in the case where it is determined to permit assigning the virtual ID to the logical volume and using the logical volume, the logical volume usage processing unit execute the logical volume usage processing which use the usage target logical volume, and in the case where it is determined not to permit assigning the virtual ID to the logical volume and using the logical volume, the logical volume usage processing unit does not execute the logical volume usage processing which use the usage target logical volume.

In addition, another aspect of a data management method of a storage system of the invention is a data management method of a storage system including a plurality of storage devices connected to a host computer, wherein each of the storage devices including a storage device and a processor, a logical volume for storing information is created in each of the storage devices, a virtual ID for identifying the logical volume is assigned to the logical volume, and the virtual ID is used to identify the logical volume to be accessed by the host computer, the storage devices store virtual ID management information which stores in association with each other, the virtual ID, a storage device ID identifying the storage device including the logical volume assigned to the virtual ID, and usage permission information indicating whether to permit assigning the virtual ID to the logical volume and using the logical volume; the method comprising: by the processor, identifying a usage target virtual ID assigned to the usage target logical volume, and the usage target storage device ID of the usage target storage device including the usage target logical volume, In the case where a logical volume identifying information for identifying a usage target logical volume which is target of use is input; and determining whether to permit assigning the virtual ID to the logical volume and using the logical volume, based on consistency with the virtual ID management information, in the case where it is determined to permit assigning the virtual ID to the logical volume and using the logical volume, the processor execute the logical volume usage processing which use the usage target logical volume; and in the case where it is determined not to permit assigning the virtual ID to the logical volume and using the logical volume, the processor does not execute the logical volume usage processing which use the usage target logical volume.

According to the invention, it is possible to prevent the destruction of data stored in logical volumes that occurs when the same ID for identifying the logical volumes is assigned to each of a plurality of logical volumes in which different data are stored.

Objects, configurations, and effects other than those described above will be obvious by the following description of Example.

### BRIEF DESCRIPTION OF THE DRAWINGS

FIG. 1 is an example of a system configuration diagram of an outline of a storage system;

FIG. 2 is a diagram illustrating an example of a function block diagram of the storage system;

FIG. 3 is a block diagram illustrating an example of a hardware configuration of a host computer;

FIG. 4 is a block diagram illustrating an example of a hardware configuration of a storage device;

FIG. 5 is a block diagram illustrating an example of a hardware configuration of a virtual ID management computer;

FIG. 6 is a diagram illustrating connection between the host computer and a logical volume of the storage device;

FIG. 7 is a diagram illustrating an example of a logical volume management table;

FIG. 8 is a diagram illustrating an example of a virtual ID management computer table;

FIG. 9 is a diagram illustrating an example of a virtual ID management record;

FIG. 10 is an explanatory diagram illustrating an outline of blocks constituting the virtual ID management record;

FIG. 11 is a diagram illustrating an example of a virtual ID history table;

FIG. 12 is an explanatory diagram illustrating an outline of processing of the storage system;

FIG. 13 is a flowchart illustrating an example of the virtual ID registration processing of Example;

FIG. 14 is a flowchart illustrating an example of virtual ID registration deletion processing of Example;

FIG. 15 is a flowchart illustrating an example of logical volume access setting processing of Example;

FIG. 16 is a flowchart illustrating an example of logical volume consistency determination processing of Example;

FIG. 17 is a flowchart illustrating an example of local copy processing in the storage device of Example; and

FIG. 18 is a flowchart illustrating an example of remote copy processing between the storage devices of Example.

### DETAILED DESCRIPTION OF THE PREFERRED EMBODIMENTS

Hereinafter, Example of the invention will be described with reference to the drawings. However, the present invention should not be construed as being limited to the description of the following examples. It is easily understood by those skilled in the art that the specific configuration can be modified without departing from the spirit and scope of the present invention.

In the configuration of the invention described below, the same or similar configurations or functions are denoted by the same reference numerals, and redundant description will be omitted.

In this specification and the like, expressions such as “first”, “second”, and “third” are used to identify components, and do not necessarily limit the number or order of components.

Herein, in this specification and the like, an expression “XX table” may be used as an example of various types of information, but the information may be expressed by a data structure such as an “XX list” or an “XX queue.” When describing the identification information, expressions such as “identification information”, “identifier”, “name”, “ID”, and “number” are used, but these can be replaced with each other.

In the examples of this specification, processing performed by executing a program may be described. Here, the computer executes a program by means of a processor (CPU, GPU, for example), and performs processing determined by the program while using storage resources (for example, memory), interface devices (for example, communication ports), or the like. Therefore, the subject of the processing performed by executing the program may be the processor. Similarly, the subject of the processing performed by executing the program may be a controller, a device, a system, a calculator, or a node including the processor. The subject of the processing performed by executing the program may be an operation unit, or may include a dedicated circuit performing specific processing. Here, the dedicated circuit, for example, is a field programmable gate array (FPGA), an application specific integrated circuit (ASIC), a complex programmable logic device (CPLD), or the like.

A program may be installed on a computer from a program source. The program source may be, for example, a program distribution server or a storage medium readable by a computer. When the program source is a program distribution server, the program distribution server may include a processor and a storage resource that stores a program to be distributed, and the processor of the program distribution server may distribute the program to be distributed to another computer. Further, two or more programs may be implemented as one program, or one program may be implemented as two or more programs.

### Example

A virtual storage system 1 (hereinafter, referred to as a storage system 1) of Example includes a plurality of storage devices 200 connected to one or more host computers 100 via a network. The storage system 1 is a system of a virtual environment. In the storage device 200, a logical volume 271 (referred to as a logical unit (LU)) for storing data as a data storage area is created.

The logical volume 271 is assigned to a virtual ID that identifies the logical volume 271. In this Example, the virtual ID is one value. Virtual IDs of various aspects can be used as the virtual ID as long as one logical volume can be specified. The virtual ID may be a set of a plurality of IDs. In this Example, In the case where a virtual ID composed of a set of a plurality of IDs is used as a virtual ID that specifies one logical volume, the virtual ID is described as one value that is a set of a plurality of IDs. For example, the host computer 100 recognizes a logical volume in a configuration including a virtual logical volume in a virtual storage device. In this case, the host computer 100 identifies one logical volume by the ID assigned to the virtual storage device and the ID assigned to the virtual logical volume. Then, in contrast to such a case, in this Example, the virtual ID is a value that is a set of the ID assigned to the virtual storage device and the ID assigned to the virtual logical volume.

The host computer 100 can distinguish the logical volumes 271 by virtual IDs, accesses the logical volume 271, and can read and write data stored in the logical volume 271.

<<Outline of System Configuration of Storage System 1>>

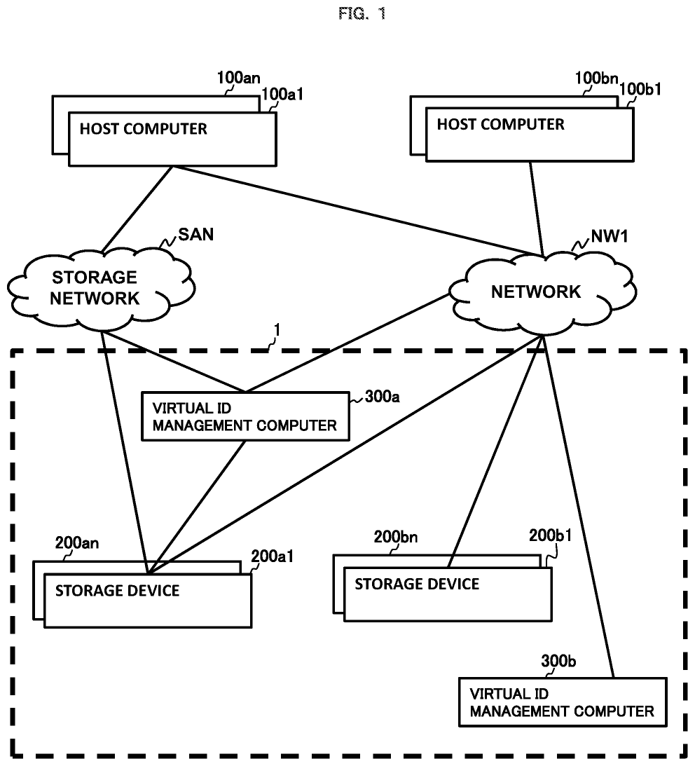

FIG. 1 is an example of a system configuration diagram of the outline of the storage system 1. As the outline is illustrated in FIG. 1, the storage system 1 includes storage devices 200a1 to 200an and 200b1 to 200bn and virtual ID management computers 300a and 300b, those are connected to host computers 100a1 to 100an and 100b1 to 100bn via networks SAN and NW1.

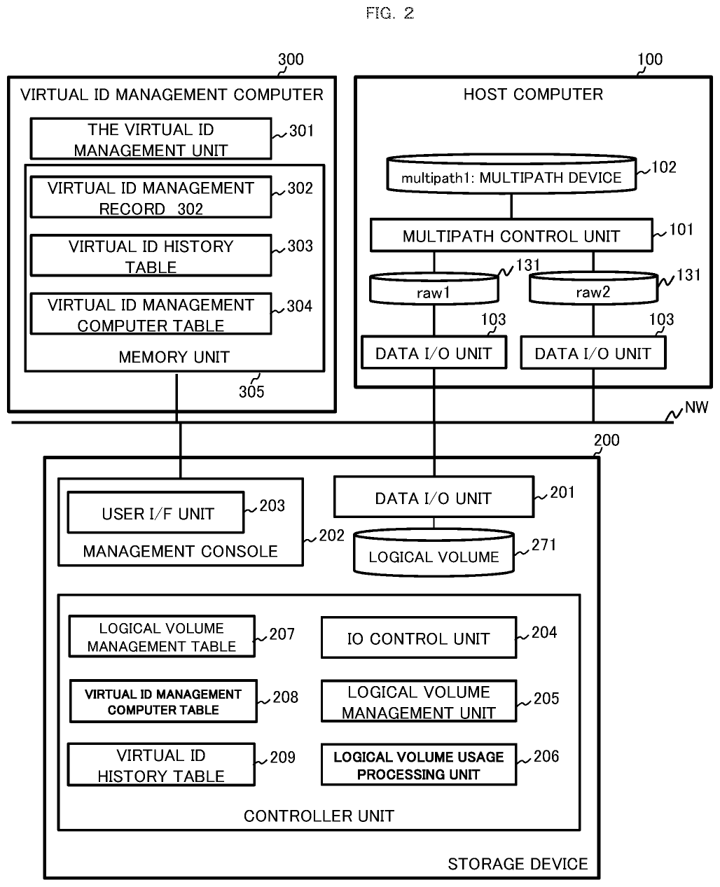

The configuration is similar among storage devices 200a1 to 200an and 200b1 to 200bn. Storage devices 200a1 to 200an and 200b1 to 200bn are generically referred to as “storage device 200”. There is no limit to the number of storage devices 200. As described below with reference to FIG. 2, the logical volume 271 to which the virtual ID is assigned, is created in the storage device 200.

The configurations are similar between the virtual ID management computers 300a and 300b. The virtual ID management computers 300a and 300b are collectively referred to as “virtual ID management computer 300”. There is no limit to the number of virtual ID management computers 300. The virtual ID management computer 300 manages virtual IDs.

The configurations are similar among the host computers 100a1 to 100an and 100b1 to 100bn. The host computers 100a1 to 100an and 100b1 to 100bn are generically referred to as “host computer 100”. There is no limit to the number of the host computers 100. The host computer 100 can access the logical volume 271 created in the storage device 200 via the network SAN and NW1, and can read and write information stored in the logical volume 271.

The network SAN is a network composed of a SAN (Storage Area Network), iSCSI, or the like. The network NW1 may be, for example, the Internet, a local area network (LAN: Local Area Network), a wired network, or a wireless network. The network SAN and the network NW1 may be computer networks as long as they are computer networks, they can be changed to computer networks other than the SAN, the Internet, and the local area network.

The storage device 200 can be placed in a variety of locations depending on the organization of a user using the storage device 200, for example, a company or the like. For example, there are cases where storage devices 200 are arranged over a wide area, such as a case where storage devices 200 are arranged in each of a plurality of countries. In addition, there are cases where a host computer 100a1 to 100an may create and use new logical volumes not only in the storage device 100a1 to 100an used by the host computer 100a1 to 100an but also in the storage device 100b1 to 100bn used by other host computers 200b1 to 200bn. In addition, the storage device 200, which has been placed and used in various places, may be connected to and used by a host computer 100 that has not been connected before due to a change in the organization to which the user of the storage device 200 belongs.

Even in such cases, the storage system 1 can prevent the data stored in the logical volumes from being destroyed by assigning the same ID for identifying the logical volume can be assigned to each of a plurality of logical volumes in which different data is stored.

<<System Configuration of Storage System 1>>

Next, the configuration of the storage system 1 will be described with reference to FIG. 2 to FIG. 5. FIG. 2 is a diagram illustrating an example of a function block diagram of the storage system 1.

<Configuration of Host Computer 100>

As illustrated in FIG. 2, the host computer 100 includes, as a function configuration, an MULTIPATH CONTROL unit 101, an MULTIPATH device 102, and a data input/output unit 103.

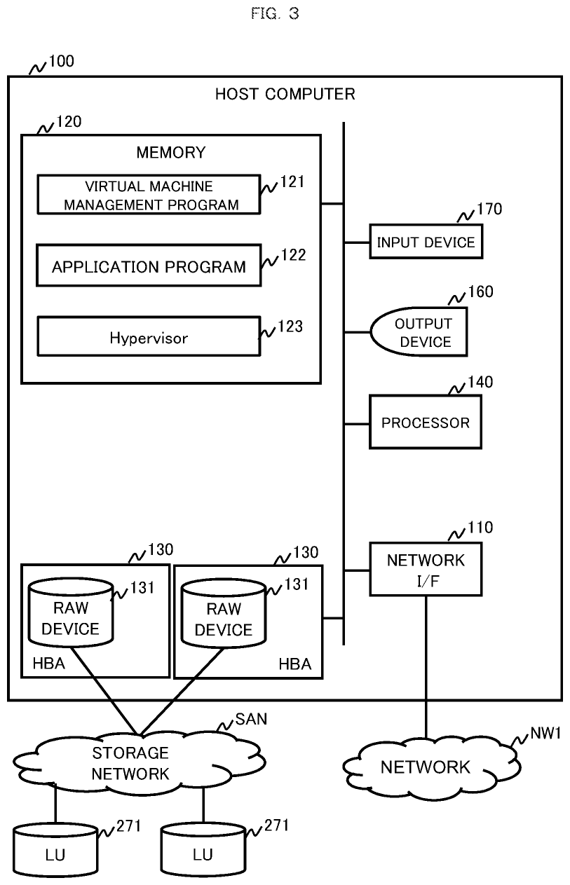

FIG. 3 is a block diagram illustrating an example of a hardware configuration of the host computer 100. As illustrated in FIG. 3, the host computer 100 is a computer including a processor 140, a memory 120, a host bus adapter (HBA) 130, an output device 160, an input device 170, a management port 110 serving as a network I/F, and the like. The host computer 100 can be realized by a general information processing apparatus such as a personal computer, a workstation, or a mainframe, for example.

The processor 140 generally controls the entire host computer 100, and realizes each function by executing programs such as the virtual machine management program 121, the application program 122, and the Hypervisor 123 stored in the memory 120. For example, the processor 140 realizes an MULTIPATH CONTROL unit 101 that issues an access request such as a read access request or a write access request to the storage device 200 by executing the Hypervisor 123. As the MULTIPATH CONTROL unit 101, an MULTIPATH device 102 (not shown in FIG. 3) can be used.

The memory 120 is used to store programs and the like, and is also used as a work memory of the processor 140.

The HBA 130 performs protocol control during communication with the storage device 200. By performing protocol control by the HBA 130, data and commands, for example, according to the Fibre Channel protocol are transmitted and received between the host computer 100 and the storage device 200. The HBA 130 corresponds to the data input/output unit 103 in FIG. 2.

The Hypervisor 123 comprises a virtual machine control unit for deploying virtual machines and a disk control unit for forming virtual disks from the raw devices 131.

The output device 160 is a device that outputs information, such as a monitor display and a speaker. The input device 170 is a device that inputs information, such as a keyboard, a switch, a pointing device, and a microphone.

<Configuration of Storage Device 200>

As illustrated in FIG. 2, the storage device 200 comprises, as functional configurations, a data input/output unit 201, a user I/F unit 203 of the management console 202, an IO CONTROL UNIT 204, a logical volume management unit 205, a logical volume usage processing unit 206, a logical volume management table 207, a virtual ID management computer table 208, and a virtual ID history table 209.

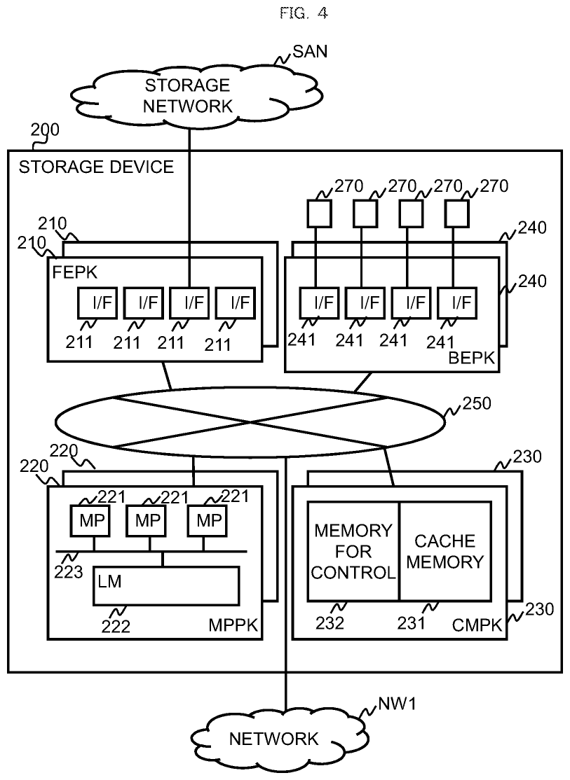

FIG. 4 is a block diagram illustrating an example of the hardware configuration of the storage device 200. As illustrated in FIG. 4, the storage device 200 includes one or more Front End PacKages (FEPK) 210 corresponding to the data input/output unit (a host I/F unit) 201 in FIG. 2, one or more Micro Processor PacKages (MPPK) 220 that are also the user I/F units (a storage control unit) 203 of the management console 202 in FIG. 2 and the IO control unit 204, one or more Cache Memory PacKages (CMPK) 230 corresponding to a shared memory units, one or more BackEnd PacKages (BEPK) 240 that are disk I/F units, and one or more memory devices 270.

An internal network 250 connects the FEPK 210, the MPPK 220, the CMPK 230, and the BEPK 240 to each other. Each MP 221 of the MPPK 220 can communicate with any one of the FEPK 210, the CMPK 230, and the BEPK 240 by the internal network 250. The FEPK 210 includes a plurality of logical ports 211 each serving as a host I/F.

The BEPK 240 includes a plurality of disk I/Fs 241. The disk I/F 241 is connected to a drive 270 via, for example, a cable, and is connected to the internal network 250. The BEPK 240 mediates processing of delivering data to be read or written between an internal network 250 side and the memory device 270.

The CMPK 230 includes a cache memory 233 for data and a memory 232 for control information. The cache memory 233 and the memory 232 for control information may be a volatile memory, for example, a Dynamic Random Access Memory (DRAM). The cache memory 233 temporarily stores (caches) data to be written to the drive 270, or temporarily stores (caches) data read from the drive 270. The memory 232 for control information stores information necessary for control (for example, configuration information of the LU 242 which is a logical volume) and a storage configuration control program.

The MPPK 220 includes a plurality of micro-processors (MP) 221, a local memory (LM) 222, and a bus 223 that connects the MPs 221 and the LM 222. The MP 221 is a processor that is also used by a computer or the like, and operates in accordance with a program stored in the LM 222. The LM 222 stores a part of control information (configuration information and the like) for I/O control stored in the memory 232 for control information a logical volume management program 205a (not illustrated), a logical volume usage processing program 206a (not illustrated), the logical volume management table 207, the virtual ID management computer table 208, and the virtual ID history table 209.

The logical volume management unit 205 is attained by the MP 221 executing the logical volume management program 205a (not illustrated) stored in the LM 222. In addition, the logical volume usage processing unit 206 is attained by the MP 221 executing the logical volume usage processing program 206a (not illustrated) stored in the LM 222.

The memory device 270 is a non-volatile memory such as a hard disk drive (HDD) or a solid state drive (SSD). The memory device 270 has the logical volume 271.

The logical volume management table 207, which will be described in detail later with reference to FIG. 7, stores information for managing the logical volume 271.

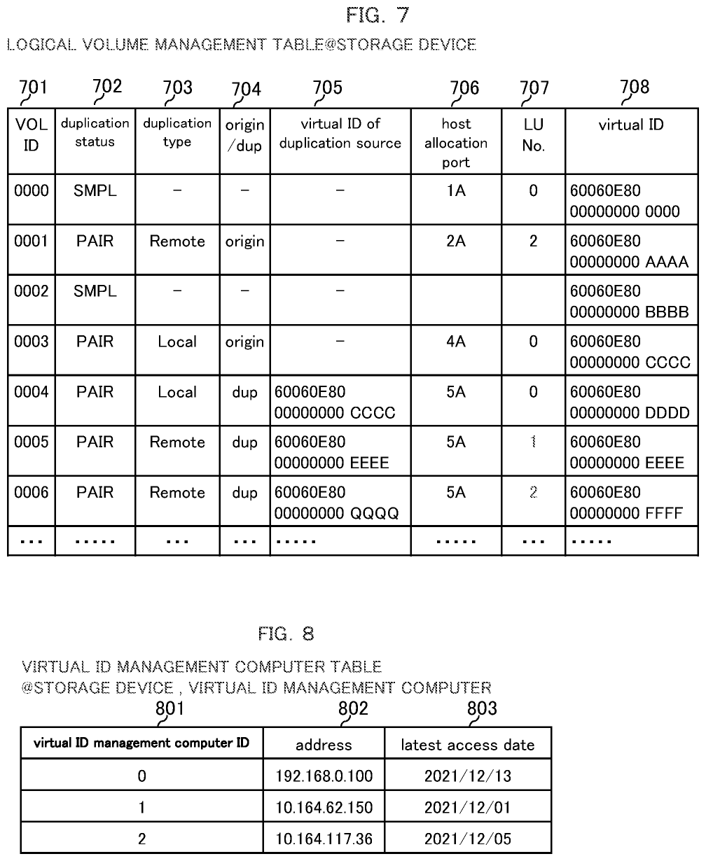

The virtual ID management computer table 208, which will be described later with reference to FIG. 8, stores information about the address of the virtual ID management computer 300.

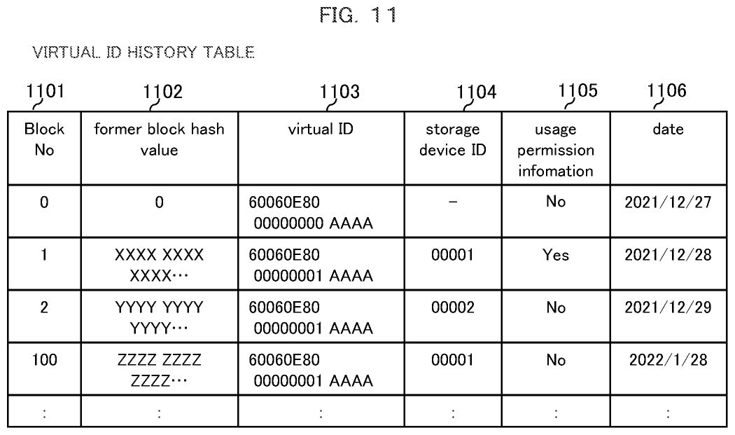

The virtual ID history table 209, which will be described later in detail with reference to FIG. 11, is a table in which all blocks (records) contain the virtual ID of the usage target are extracted from the virtual ID management record 302 stored in the virtual ID management computer 300 and put together in a table format.

<Configuration of Virtual ID Management Computer 300>

As illustrated in FIG. 2, the virtual ID management computer 300 includes a virtual ID management unit 301, and the virtual ID management record (virtual ID management information) 302, a virtual ID history table 303, and a virtual ID management computer table 304, which are stored in a memory unit 305, as a function configuration.

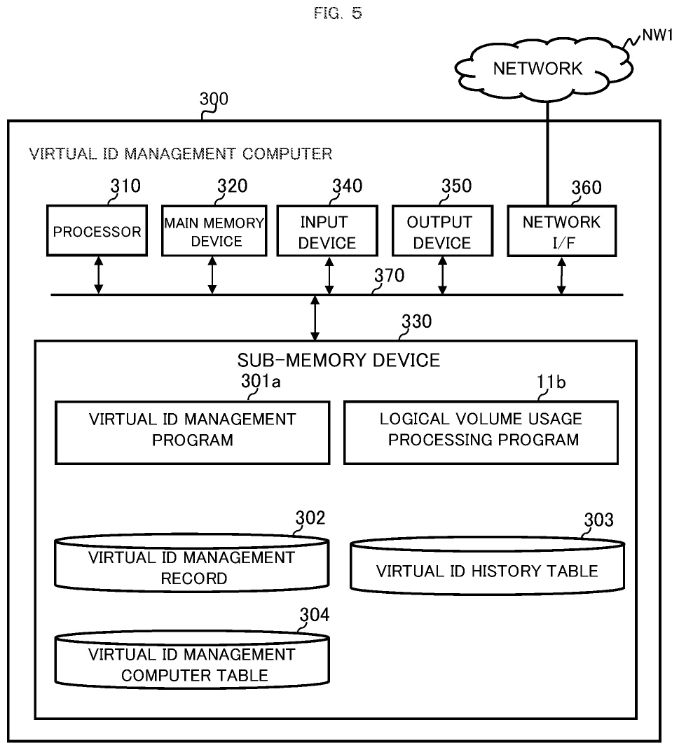

FIG. 5 is a block diagram illustrating an example of a hardware configuration of the virtual ID management computer 300. As illustrated in FIG. 5, the virtual ID management computer 300 includes as a hardware configuration, a processor 310, a main memory device 320, a sub-memory device 330, an input device 340, an output device 350, a network I/F 360, and a bus 370 connecting devices described above. The virtual ID management computer 300 can be realized by a general information processing apparatus such as a personal computer, a workstation, or a mainframe, for example.

The processor 310 controls each unit of the virtual ID management computer 300, reads data and programs stored in the sub-memory device 330 to the main memory device 320, and executes processing determined by the programs. The virtual ID management unit 301 is realized by the processor 310 reading the virtual ID management program 301a stored in the sub-memory device 330 to the main memory device 320 and executing the program. In this specification, In the case where processing is described in a sentence whose subject is the virtual ID management unit 301, it indicates that the processor 310 of the virtual ID management computer 300 is executing the virtual ID management program 301a that realizes the functional unit.

The main memory device 320 is a RAM or the like, includes a volatile memory element, and stores programs executed by the processor 310, and data.

The sub-memory device 330 is an HDD (Hard Disk Drive), SSD (Solid State Drive), or the like, which has a nonvolatile storage element and stores programs, data, and the like. The sub-memory device 330 is a memory unit 305 that stores a virtual ID management program 301a, a virtual ID management record 302 in the form of a block chain, a virtual ID history table 303, and a virtual ID management computer table 304.

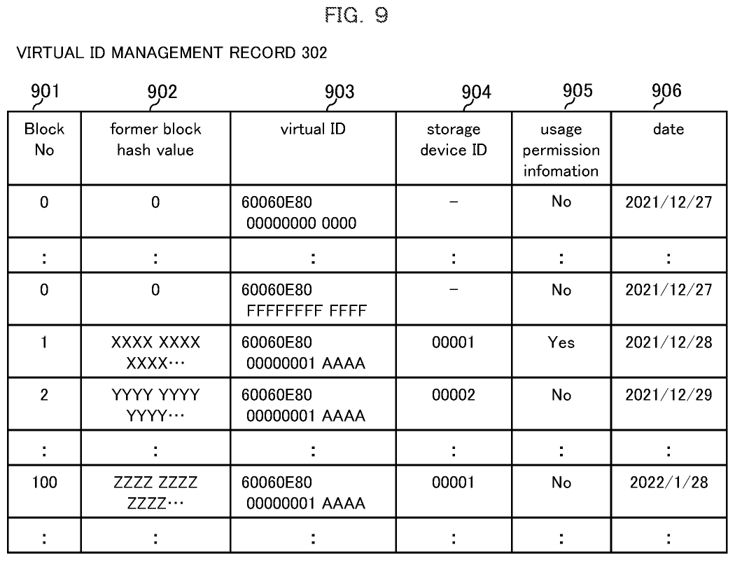

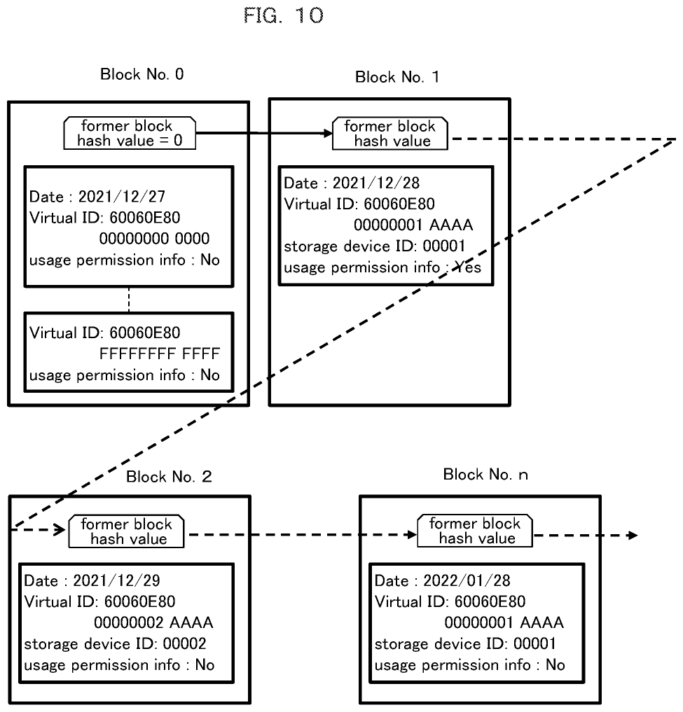

The details of the virtual ID management record 302 which will be described in detail later with reference to FIGS. 9 and 10, stores the information in which the virtual ID, a storage device ID identifying the storage device 200, and usage permission information indicating whether to permit assigning the virtual ID to the logical volume 271 and using the logical volume 271, are associated with each other, in the form of a block chain.

The virtual ID history table 303, which will be described in detail later with reference to FIG. 11, and the virtual ID history table is the same table as the virtual ID history table 209 stored in the storage device 200, and the virtual ID history table 303 is a table in which all blocks (records) containing the usage target virtual ID are extracted from the virtual ID management record 302 stored in the virtual ID management computer 300 and put together in a table format.

The virtual ID management computer table 304, which will be described in detail later with reference to FIG. 8, is the same table as the virtual ID management computer table 208. The virtual ID management computer table 304 is stored in the storage device 200, and stores information about the address of the virtual ID management computer 300.

The input device 340 is a device that inputs information, such as a keyboard, a switch, a pointing device, and a microphone. The output device 350 is a device that outputs information, such as a monitor display and a speaker.

The network I/F 360 is connected to a network such as the network NW1 or SAN, and is an interface (transmission/reception device) capable of transmitting/receiving data to/from the storage device 200 via the network NW1 or SAN.

<<Data Configuration of Storage System 1>>

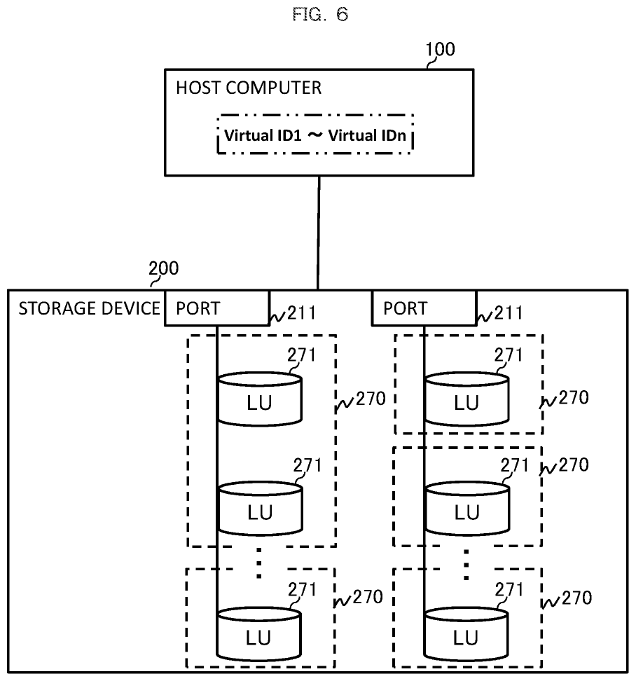

Next, the data configuration of various types of data used in the storage system 1 will be described with reference to FIG. 6 to FIG. 11.

FIG. 6 is a diagram illustrating connection between the host computer 100 and the logical volume 271 of the storage device 200. As illustrated in FIG. 6, the logical volume 271 is created in the memory device 270 of the storage device 200, and the virtual ID is assigned to the memory device 270. The logical volume 271 is connected to the port 211. The host computer 100 is connected to the port 211 of the storage device 200, and accesses the logical volume 271 via the port 211. There are a plurality of ports 211. A plurality of logical volumes 271 can be connected to one port 211. The virtual ID and the logical volume 271 are associated with each other, and the host computer 100 identifies the logical volume 271 with the virtual ID.

In the case where the user creates the logical volume 271 in the memory device 270 of the storage device 200, the user assigns the virtual ID created by the user to the logical volume 271. Accordingly, the logical volume 271 to which the same virtual ID is assigned, may be created in each of different storage devices 200.

Then, the storage system 1 is can synchronize the logical volumes 271 between the storage devices with each other; by using the logical volume 271 connected to the port 211 as a copy source, and the logical volume 271 created in another storage device 200 different from the storage device 200 including the logical volume 271 of the copy source, as a copy destination.

In addition, in a case where the logical volume 271 is not connected to the port 211, the host computer 100 is not accessible to the logical volume 271. The storage device 200 set the storage device 200 to associate the port with the logical volume 271, so that the host computer 100 can access the logical volume 271.

FIG. 7 is a diagram illustrating an example of a data configuration of the logical volume management table 207. The logical volume management table 207 is stored in the storage device 200. The logical volume management table 207 includes, as fields, a volume ID 701, a duplication status 702, a duplication type 703, a copy relations 704, a virtual ID of a duplication source 705, a host allocation port 706, a LU number 707, and a virtual ID 708.

The volume ID 701 is an ID for identifying the logical volume 271 in the storage device 200. The duplication status 702 indicates the type of synchronization of the logical volume 271. In the duplication status 702, two types of values are stored, “SMPL” representing that synchronization is not performed and “PAIR” representing that synchronization is performed.

The duplication type 703 is the type of synchronization of the logical volume 271. The duplication type 703 stores two types of values, “Local” representing that the logical volume 271 is synchronized within the storage device, and “Remote” representing that the logical volume 271 is synchronized between the storage devices. The copy relation 704 indicates whether the logical volume 271 is a copy source or a copy destination. The copy relation 704 stores two types of values, “origin” representing the logical volume 271 as the copy source and “dup” representing the logical volume 271 as the copy destination.

The virtual ID of a duplication source 705 stores the virtual ID of the logical volume 271 of the copy source when the logical volume 271 is the copy destination. The host allocation port 706 is the port ID of the port associated with the logical volume 271. The LU number 707 is an ID for the logical volume 271 that identifies the logical volume 271 for each port. The virtual ID 708 is an ID for the logical volume 271 that allows the host computer 100 to identify the logical volume 271.

For example, in a record whose volume ID is 0004, the duplication status 702 is “PAIR” indicating that synchronization is being performed, and the duplication type 703 is “Local” indicating that the logical volume 271 is being synchronized in the storage device. The copy relations 704 is “dup” indicating that the logical volume 271 is a copy destination, and the virtual ID of the duplication source (copy source) is “60060E80 00000000 CCCC”. The logical volume 271 is associated with a port whose host allocation port 706 is “5A” by a port ID of LU number 707 “0”. The virtual ID of the logical volume 271 is “60060E80 00000000 DDDD”.

In the record whose volume ID is 0005, the duplication type 703 is “Remote” indicating that the logical volume 271 is being synchronized between storage devices. The virtual ID of the replication source (copy source) 705 is “60060E80 00000000 EEEE” identical to the virtual ID 708. In this way, the virtual IDs of the two logical volumes 271 that are synchronizing the logical volume 271 between storage devices can be the same. In this case, the logical volume 271 of the copy source (replication source) is connected to the port.

On the other hand, in the record whose volume ID is 0006, the duplication type 703 is “Remote” indicating that the logical volume 271 is synchronized between the storage devices, and the virtual ID of the duplication source 705 (copy source) is “60060E80 00000000 QQQQ”, which is different from the virtual ID 708 “60060E80 00000000 FFFF”. In this way, the virtual IDs of the two logical volumes 271 that are synchronized between the storage devices can also be made different from each other.

FIG. 8 is a diagram illustrating an example of a data configuration of the virtual ID management computer tables 208 and 304. The virtual ID management computer tables (208 and 304) are stored in the storage device 200 and the virtual ID management computer 300. The virtual ID management computer tables 208 and 304 include, as a field, a virtual ID management computer ID 801 for identifying the virtual ID management computer 300, an address 802 that is an IP address of the virtual ID management computer 300, and the latest access date 803 that stores the latest access date to the virtual ID management computer 300.

FIG. 9 is a diagram illustrating an example of a data configuration of the virtual ID management record 302. The virtual ID management record 302 is shared with a plurality of virtual ID management computers 300 in the form of a block chain. In FIG. 9, the virtual ID management record 302 is shown in the form of a table, but the virtual ID management record 302 is stored in the storage device 200 in the form of a block chain. The records and blocks of the logical volume management table 207 are arranged in time series order.

FIG. 10 is an explanatory diagram illustrating the outline of blocks constituting the virtual ID management record 302.

As shown in FIG. 9, the virtual ID management record 302 has, as fields, block number 901, former block hash value 902, virtual ID 903, storage device ID 904, usage permission information 905, and date 906.

The block number 901 is a number for identifying a block. The former block hash value 902 is a hash value obtained by substituting data of the most recently created block of the generating block into a hash function. The data of the block to be substituted into the hash function is, for example, a value obtained by appropriately selecting one or more values from the block number 901, the former block hash value 902, the virtual ID 903, the storage device ID 904, the usage permission information 905, and the date 906.

The virtual ID 903 is the virtual ID of the logical volume 271. The storage device ID 904 is an ID for identifying the storage device 200. The value of the storage device ID 904 may be a serial number of the storage device 200.

The usage permission information 905 indicating whether to permit assigning the virtual ID to the logical volume 271 and using the logical volume 271. In the usage permission information 905, two types of values are stored, “Yes” indicating to permit assigning the virtual ID to the logical volume 271 and using the logical volume 271 and “No” indicating not to permit assigning the virtual ID to the logical volume 271 and using the logical volume 271.

The date 906 is a data on which the block is created, and the date 906 may be the date and time.

The record whose block number 901 is 0 is the record of the initial setting. In the entire record whose block number 901 is 0, all possible values of the virtual ID 903 are stored, and since the logical volume 271 is not generated at the time of the initial setting, the value of the usage permission information is “No” in all the records.

For example, a record whose block number 901 is 1 has a virtual ID 903 of “60060E80 00000000 AAAA”, a storage device ID of “00001”, and usage permission information of “Yes”. A record whose block number 901 is 1 is an example of a record (block) generated when a logical volume 271 is created.

Then, the record whose block number 901 is 2 has a virtual ID 905 of “60060E80 00000000 AAAA” which is the same as the record whose block number 901 is 1. The record whose block number 901 is 2 is an example of a record (block) generated when a virtual ID already assigned to another logical volume 271 is assigned to a newly generated logical volume 271.

In the record whose block number 901 is 1, because the usage permission information is “Yes”, assigning the virtual ID to the logical volume 271 and using the logical volume 271 is permitted. On the other hand, in the record whose block number 901 is 2, because the usage permission information 905 is “No”, assigning the virtual ID to the logical volume 271 and using the logical volume 271 is not permitted.

Here, the virtual ID 705 “60060E80 00000000 AAAA” has already been assigned to the logical volume 271 created with storage device ID “00001” of the record whose block number 901 is 1. The virtual ID 705 of the record whose block number 901 is 2 is the same as the virtual ID 705 of the record whose block number 901 is 1. In the record whose block number 901 is 2, for the recorded logical volume 271, the usage permission information 905 is “No”. In the record whose block number 901 is 2, assigning the virtual ID “60060E80 00000000 AAAA” to the logical volume 271 and using the logical volume 271 is not permitted. As a result, the logical volume 271 recorded in the record whose block number 901 is 1 can be used, but the logical volume 271 recorded in the record whose block number 901 is 2 cannot be used.

Then, the record whose block number 901 is 100 is an example of a record (block) generated when the logical volume 271 recorded in the record whose block number 901 is 1, is deleted. The record whose block number 901 is 100 and the record whose block number 901 is 1, have the same virtual ID and storage device ID. The record whose block number 901 is 1, records the creation of the logical volume 271 with the usage permission information is “Yes”. On the other hand, the record whose block number 901 is 100, records the deletion of the logical volume 271 with the usage permission information is “No”. In this way, after the logical volume 271 associated with “Yes” in the usage permission information, is deleted, it is possible to permit assigning the virtual ID of the deleted logical volume 271 to the logical volume 271 and using the logical volume 271. Thus, the host computer 100 can access and use the logical volume 271 newly assigned by the virtual ID of the deleted logical volume 271.

FIG. 11 is a diagram illustrating an example of a data configuration of the virtual ID history tables 209 and 303. The virtual ID history tables 209 and 303 have the same fields as the virtual ID management record 302: block number 1101, former block hash value 1102, virtual ID 1103, storage device ID 1104, usage permission information 1105, and date 1106. These fields are the same as the virtual ID management record 302 shown in FIG. 9.

<<Processing Procedure>>

<Outline of Processing>

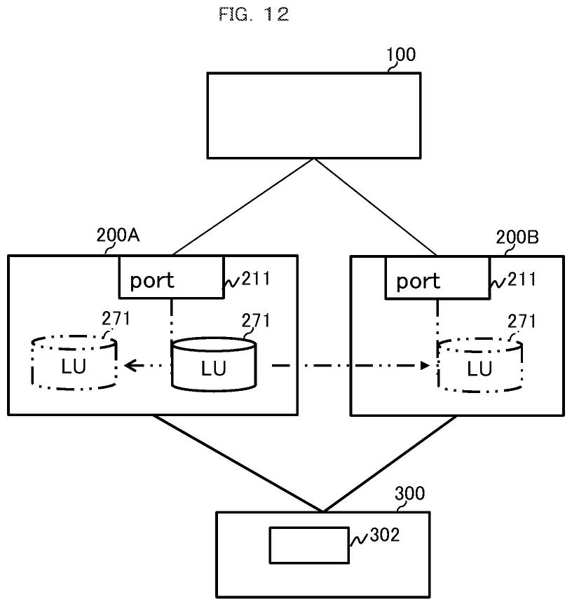

FIG. 12 is an explanatory diagram illustrating the outline of the processing of the storage system 1.

Next, the outline of the processing procedure of the storage system 1 will be described with reference to FIG. 12. First, the outline of the processing executed by the storage device 200 will be described. The storage device 200 executes the following processes (A) to (F). Among them, the processes (A) and (B) are the processes executed by the logical volume management unit 205 of the storage device 200. The processes (C) to (F) are the logical volume usage processing executed by the logical volume usage processing unit 206 of the storage device 200.

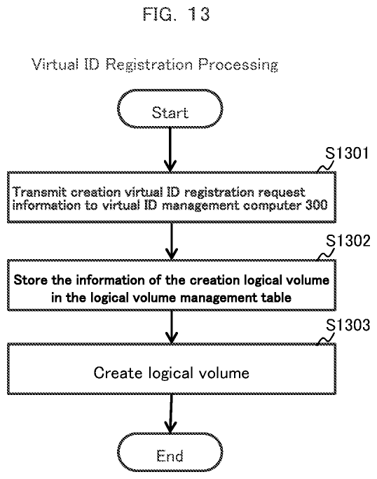

(A) Virtual ID Registration Processing (FIG. 13); The logical volume management unit 205 of the storage device 200 transmits information about the virtual ID assigned to the logical volume 271 to be created, to the virtual ID management computer 300, and creates the logical volume 271.

(A1) Virtual ID Registration Record Processing; The virtual ID management unit 301 of the virtual ID management computer 300 generates a block in the form of a block chain of information about the virtual ID assigned to the logical volume 271 to be created, which was transmitted from a storage device executing (A) Virtual ID Registration Processing. The virtual ID management unit 301 shares the generated block with a plurality of virtual ID management computers 300. And the virtual ID management unit 301 adds the block to the virtual ID management record 302.

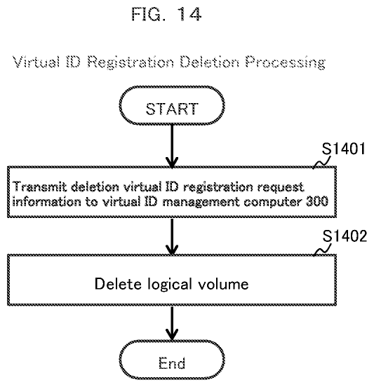

(B) Virtual ID Registration Deletion Processing (FIG. 14); The logical volume management unit 205 of the storage device 200 transmits information about the virtual ID of the logical volume 271 to be deleted, to the virtual ID management computer 300, and the logical volume management unit 205 deletes the logical volume 271.

(B1) Virtual ID Registration Deletion Record Processing; the virtual ID management unit 301 of the virtual ID management computer 300 generates a block in the form of a block chain, regarding the virtual ID of the logical volume 271 to be deleted. The virtual ID management unit 301 shares the generated block with a plurality of virtual ID management computers 300. And the virtual ID management unit 301 adds the block to the virtual ID management record 302.

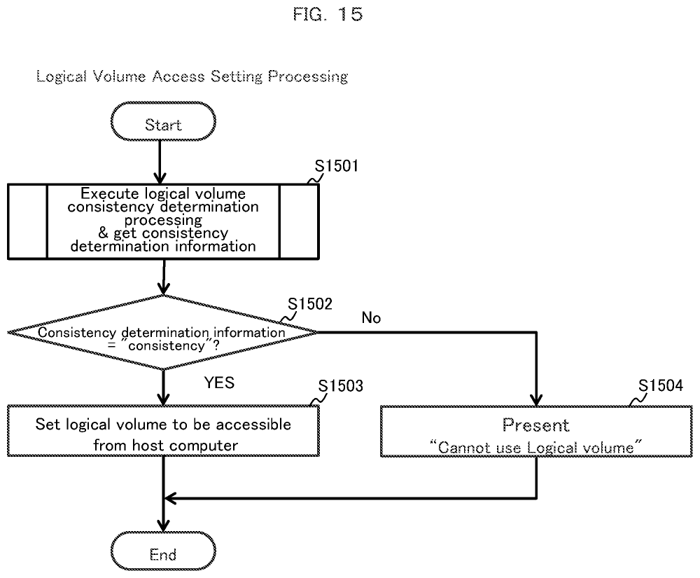

(C) Logical Volume Access Setting Processing (FIG. 15); The logical volume usage processing unit 206 of the storage device 200 sets the storage device 200 so that the host computer 100 can access the logical volume 271 based on the determination of (D) Logical Volume Consistency Determination Processing.

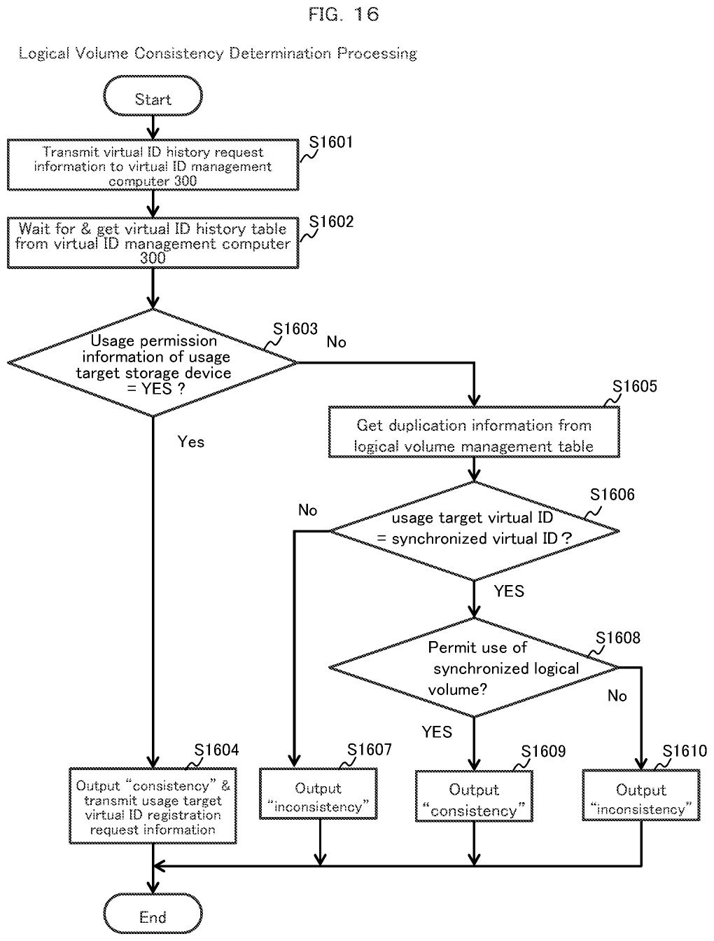

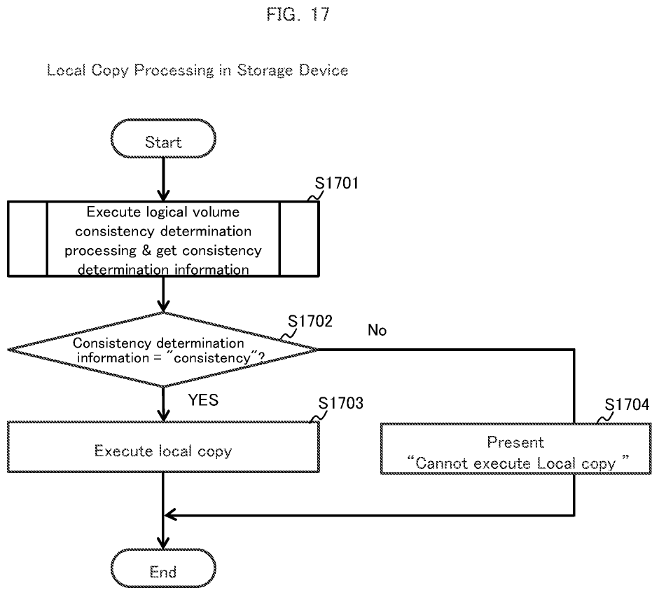

(D) Logical Volume Consistency Determination Processing (FIG. 16); the logical volume usage processing unit 206 of the storage device 200 determines whether to permit assigning the virtual ID to the logical volume and using the logical volume.

(D1) Virtual ID History Table Generation Processing; The virtual ID management computer 300 receives information about the virtual ID of the logical volume 271 of the usage target, from the storage device 200 that executes (D) Logical Volume Consistency Determination Processing. The virtual ID management unit 301 of the virtual ID management computer 300 uses the received information about the virtual ID of the logical volume 271 of the usage target, to generate a virtual ID history table that summarizes records relating to the virtual ID of the logical volume 271 of the usage target, of the virtual ID management record 302. The virtual ID management unit 301 returns the generated virtual ID history table to the storage device 200.

(D2) Usage Target Virtual ID Record Processing; In the case where it is determined to permit assigning the virtual ID to the logical volume and using the logical volume (Yes) in (D) Logical Volume Consistency Determination Processing, a virtual ID management unit 301 of a virtual ID management computer 300 generates a block in the form of a block chain. The generated block is relating to the usage target logical volume. The virtual ID management unit 301 shares the generated block with a plurality of virtual ID management computers 300. And the virtual ID management unit 301 adds the block to the virtual ID management record 302.

(E) Local Copy Processing in Storage Device (FIG. 17); the logical volume usage processing unit 206 of the storage device 200 creates a copy of the logical volume 271 in the storage device based on the determination by the (D) Logical Volume Consistency Determination Processing.

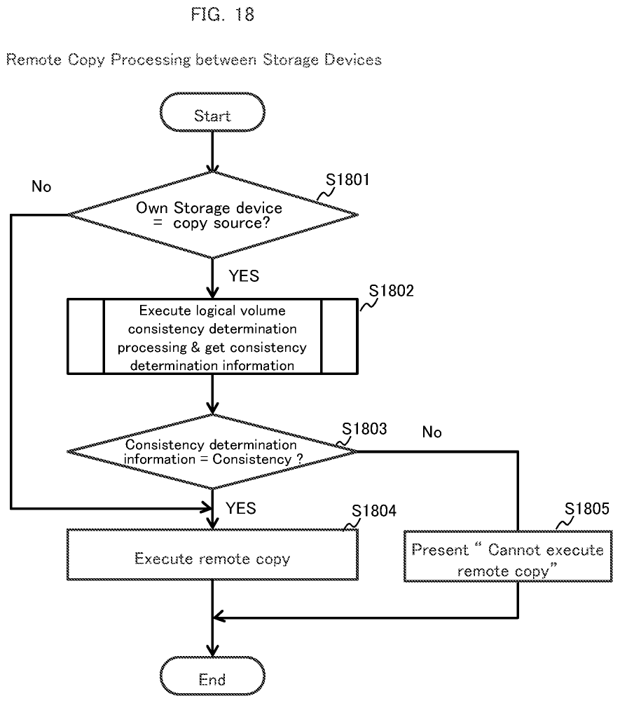

(F) Remote Copy Processing between Storage Devices (FIG. 18); The logical volume usage processing unit 206 of the storage device 200 makes a copy of the logical volume 271 between storage devices (between 200A and 200B in FIG. 12) based on the determination by (D) the Logical Volume Consistency Determination Processing.

Here, (C) Logical Volume Access Setting Processing, (E) Local Copy Processing in Storage Device, and (F) Remote Copy Processing between Storage Devices are examples of logical volume usage processing using the usage target logical volume that is the usage target. When executing (C) Logical Volume Access Setting Processing, (E) Local Copy Processing in Storage Device, and (F) Remote Copy Processing between Storage Devices, the user of storage device 200 (usage target storage device) inputs logical volume identifying information and the like. Here, the user inputs logical volume identifying information to the logical volume (usage target logical volume), which is the usage target, by inputting path or right-clicking. The logical volume identifying information is information that identifies the usage target logical volume. The logical volume identifying information is information associated with the volume ID 701 of the logical volume management table 207 (see FIG. 7) and is information that can identify the logical volume.

<(A) Virtual ID Registration Processing, FIG. 13>

FIG. 13 is a flowchart illustrating an example of the virtual ID registration processing of the Example. A user inputs, to the storage device 200, an area of the storage device 200 to be allocated to the logical volume 271 (hereinafter referred to as a creation logical volume) to be created and a virtual ID (hereinafter referred to as a creation Virtual ID) to be assigned to the creation logical volume 271. Then, the logical volume management unit 205 of the storage device 200 executes Virtual ID Registration Processing.

The storage device 200 transmits as virtual ID registration request information, creation Virtual ID registration request information, including the input creation Virtual ID for the creation logical volume to be created, the own storage device ID (hereinafter, sometimes referred to as creation storage device ID), and a record request information requesting that information about the creation logical volume to be stored in the virtual ID management record (virtual ID management information) 302, to at least one virtual ID management computer 300 among the plurality of virtual ID management computers 300 (step 1301). The virtual ID registration request information is information including, the virtual ID, the own storage device ID, and record request information that is requesting the information to be stored in the virtual ID management record (virtual ID management information) 302.

When the virtual ID management computer 300 receives creation Virtual ID registration request information from the storage device 200, the virtual ID management computer 300 executes (A1) Virtual ID Registration Record Processing, as described below. In (A1) Virtual ID Registration Record Processing, the virtual ID management computer 300 generates a block about creation logical volume 271; the virtual ID management unit 301 shares the generated block with a plurality of virtual ID management computers 300; and the virtual ID management unit 301 updates the virtual ID management record 302.

Next, the storage device 200 stores the information of the creation logical volume 271 in the logical volume management table 207 (refer to FIG. 7) (step S1302). Here, in the logical volume management table 207, a new record including the VOL ID 701, “SMPL” in the duplication status 702, and the creation virtual ID in the virtual ID 708 are stored.

Next, the storage device 200 creates the creation logical volume 271 to which the creation virtual ID is assigned, and ends the processing (step S1303). As described above, regardless of the value of the creation Virtual ID, the creation of the creation logical volume 271 is recorded in the virtual ID management record 302 and the creation of the creation logical volume 271 is performed.

<(A1) Virtual ID Registration Record Processing (not Illustrated)>

When the virtual ID management unit 301 of the virtual ID management computer 300 receives creation Virtual ID registration request information from the storage device 200 that is executing (A) Virtual ID Registration Processing, the virtual ID management unit 301 executes Virtual ID Registration Record Processing.

The virtual ID management computer 300 determines whether to permit assigning the virtual ID to the logical volume and using the logical volume, based on consistency with the virtual ID management information, based on the creation Virtual ID, the creation storage device ID, and the record request information requesting that information about the creation logical volume be stored in the virtual ID management record (virtual ID management information) 302, which are included in the received creation Virtual ID registration request information.

Here, the virtual ID management computer 300 calculates “to permit assigning the virtual ID to the logical volume and using the logical volume (Yes)” or “not to permit the usage permission information (No)”, as follows.

That is, in the virtual ID management record 302, In the case where the usage permission information, stored in the most recently created record among the records storing the creation Virtual ID included in the creation Virtual ID registration request information, is “not permitted (No)”, the virtual ID management computer 300 calculates that “to permit assigning the virtual ID to the logical volume and using the logical volume (Yes)”. On the other hand, In the case where the usage permission information stored in the most recently created record is “permitted (Yes)”, the virtual ID management computer 300 calculates that “not to permit the usage permission information (No)”.

In the case where it is determined to permit assigning the virtual ID to the logical volume and using the logical volume (Yes), the virtual ID management computer 300 generates the usage permission information indicating to permit assigning the virtual ID to the logical volume and using the logical volume (Yes). Then, the virtual ID management computer 300 calculates the hash value by assigning the hash value (the recent hash value) of the recently created block, the creation virtual ID and the storage device ID which are included in the received creation virtual ID registration request information, and the generated usage permission information (Yes) to a predetermined hash function.

Further, the virtual ID management computer 300 generates a permission block including the calculated hash value, the creation virtual ID and the storage device ID which are included in the received creation virtual ID registration request information, and the calculated usage permission information. The virtual ID management computer 300 transmits the generated permission block to a plurality of virtual ID management computers 300, to share the permission block. And the virtual ID management computer 300 updates the virtual ID management record 302 (virtual ID management information) with using the generated permission block.

On the other hand, In the case where it is determined not to permit assigning the virtual ID to the logical volume and using the logical volume (No), the virtual ID management computer 300 generates the usage permission information indicating not to permit assigning the virtual ID to the logical volume and using the logical volume (No).

Then, the virtual ID management computer 300 calculates the hash value by assigning the hash value (the recent hash value) of the recently created block, the creation virtual ID and the storage device ID which are included in the received creation virtual ID registration request information, and the generated usage permission information (No) to a predetermined hash function.

Further, the virtual ID management computer 300 generates a permission stop block including the calculated hash value, the creation virtual ID and the storage device ID which are included in the received creation virtual ID registration request information, and the calculated usage permission information. The virtual ID management computer 300 transmits the generated permission stop block to a plurality of virtual ID management computers 300, to share the permission block. And the virtual ID management computer 300 updates the virtual ID management record 302 (virtual ID management information) with using the generated permission stop block.

<(B) Virtual ID Registration Deletion Processing, FIG. 14>

FIG. 14 is a flowchart illustrating an example of the virtual ID registration deletion processing of the Example. In the case where a user inputs information (logical volume identifying information) for identifying a logical volume 271 to be deleted (hereinafter referred to as a deletion logical volume) to the storage device 200, the logical volume management unit 205 of the storage device 200 calculate a virtual ID (hereinafter referred to as a deletion virtual ID) for the deletion logical volume 271 with reference to the logical volume management table 207. And the logical volume management unit 205 of the storage device 200 executes Virtual ID Registration Deletion Processing.

The storage device 200 transmits as virtual ID registration request information, deletion Virtual ID registration request information, including the deletion Virtual ID for the deletion logical volume to be deleted, the own storage device ID (hereinafter, sometimes referred to as deletion storage device ID), and a record request information requesting that information about the deletion logical volume to be stored in the virtual ID management record (virtual ID management information) 302, to at least one virtual ID management computer 300 among the plurality of virtual ID management computers 300 (step 1401).

The details will be described below, when the virtual ID management computer 300 receives deletion Virtual ID registration request information from the storage device 200, the virtual ID management computer 300 executes (B1) Virtual ID Registration Deletion Record Processing. In (B1) Virtual ID Registration Deletion Record Processing, the virtual ID management computer 300 generates a permission stop block. The virtual ID management unit 301 shares the generated permission stop block with a plurality of virtual ID management computers 300. And the virtual ID management unit 301 updates the virtual ID management record 302.

Next, the storage device 200 deletes the deletion logical volume 271 and ends the processing (step S1402). Here, the storage device 200 deletes the record related to the deletion logical volume 271 stored in the logical volume management table 207.

<(B1) Virtual ID Registration Deletion Record Processing (not Illustrated)>

When the virtual ID management unit 301 of the virtual ID management computer 300 receives deletion Virtual ID registration request information from the storage device 200 that is executing (B) Virtual ID Registration Deletion Processing, the virtual ID management unit 301 executes Virtual ID Registration Deletion Record Processing.

In the Virtual ID Registration Deletion Processing, the virtual ID management computer 300 generates the usage permission information indicating not to permit assigning the virtual ID to the logical volume and using the logical volume (No).

Next, the virtual ID management computer 300 calculates the hash value by assigning the recent hash value of the recently created block, the deletion virtual ID and the storage device ID which are included in the received deletion virtual ID registration request information, and the generated usage permission information (No) to a predetermined hash function.

Next, the virtual ID management computer 300 generates a permission stop block including the calculated hash value, the deletion virtual ID and the deletion storage device ID which are included in the received deletion virtual ID registration request information, and the calculated usage permission information.

Next, the virtual ID management computer 300 transmits the generated permission stop block to a plurality of virtual ID management computers 300, to share the permission block. And the virtual ID management computer 300 updates the virtual ID management record 302 (virtual ID management information) with using the generated permission stop block.

<(C) Logical Volume Access Setting Processing, FIG. 15>

FIG. 15 is a flowchart illustrating an example of the logical volume access setting processing of Example. As described above, the storage device 200 set the storage device 200 to associate the port with the logical volume 271, so that the host computer 100 can access the logical volume 271. The user inputs, to the storage device 200, logical volume identifying information for identifying a logical volume 271 (hereinafter referred to as a setting logical volume) associated with the port, and a port number (hereinafter referred to as a setting port number). The logical volume usage processing unit 206 of the storage device 200 calculate a virtual ID (hereinafter referred to as a setting virtual ID) associated with the setting logical volume 271, with reference to the logical volume management table 207. And the storage device 200 executes the Logical Volume Access Setting Processing by using the setting virtual ID and the setting port number as input. Here, instead of the storage device 200 calculating the setting virtual ID, the user may input the setting virtual ID.

The storage device 200 executes (D) Logical Volume Consistency Determination Processing (refer to FIG. 16), described below, by using the setting virtual ID and the own storage device ID (hereinafter, may be referred to as a setting storage device ID) as input, and acquires consistency determination information (step S1501). The details will be described below, and the consistency determination information includes information indicating either “consistency” or “inconsistency”.

As described below, “consistency” indicates that it is possible to permit using the logical volume with assigned the setting virtual ID. On the other hand, “inconsistency” indicates that it is not possible to permit using the logical volume with assigned the setting virtual ID.

Next, the storage device 200 determines whether the consistency determination information indicates “consistency” (step S1502).

In the case where it is determined that the consistency determination information indicates “consistency” (step S1502: Yes), the storage device 200 set so that the host computer 100 can access the logical volume 271 with assigned the setting virtual ID, and ends the processing (step S1503). In the processing of step S1503, the storage device 200 set so that the host computer 100 can access the logical volume 271 with assigned the setting virtual ID, by the storage device 200 associating the port with the logical volume 271 with assigned the setting virtual ID.

On the other hand, if it is determined that the consistency determination information indicates inconsistency but not consistency (Step S1502: No), the storage device 200 presents the information that indicate “Cannot permit assigning the virtual ID to the logical volume 271 and using the logical volume 271”, and ends the processing (step S1504). In step S1504, the storage device 200 does not associate the port with the logical volume 271 with assigned the setting virtual ID. Namely, the storage device 200 does not set so that the host computer 100 can access the logical volume 271 with assigned the setting virtual ID. In addition, the presentation of “Cannot permit assigning the virtual ID to the logical volume 271 and using the logical volume 271” may be presented to the user by, for example, the storage device 200 outputting to display an image with characters or symbols representing “Cannot permit assigning the virtual ID to the logical volume 271”, or may be presented to the user by voice.

<(D) Logical Volume Consistency Determination Processing, FIG. 16>

FIG. 16 is a flowchart illustrating an example of the logical volume consistency determination processing of Example. The logical volume usage processing unit 206 of the storage device 200 executes the logical volume consistency determination processing by using the virtual ID (hereinafter, referred to as a usage target virtual ID) and the own storage device ID (hereinafter, referred to as a usage target storage device ID) as input. Note that, hereinafter, the logical volume 271 to which the usage target virtual ID is assigned is referred to as a usage target logical volume.

The storage device 200 transmits the virtual ID history request information including the usage target virtual ID, the own storage device ID (the usage target storage device ID), and information for requesting the virtual ID history table to the virtual ID management computer 300 (step S1601). When the Virtual ID management computer 300 receive the virtual ID history table request information, the Virtual ID management computer 300 executes Virtual ID History Table Generation Processing as described later, generate a virtual ID history table by extracting all blocks (records) containing the usage target virtual ID rom the virtual ID management record 302 and putting together in a table format. Then, the virtual ID management computer 300 transmits the generated virtual ID history table to the storage device 200. Note that, when the usage target logical volume 271 is created, logical volume 271 associated with the usage target virtual ID is created, and the virtual ID history table includes a record whose Block No is not “0”.

Next, the storage device 200 waits for the reception of the virtual ID history table that is transmitted from the virtual ID management computer 300, and acquires the virtual ID history table (step S1602).

Next, the storage device 200 determines whether to perm it assigning the virtual ID to the logical volume 271 and using the logical volume 271 (Usage Permission Information=permitted (Yes)), with reference to the virtual ID history table (step S1603). Here, in a case where by satisfying both of the following two conditions of Conditions 1 and 2, it is determined to permit assigning the virtual ID to the logical volume 271 and using the logical volume 271, (step S1603: Yes), the processing proceeds to step S1604. On the other hand, in a case where by not satisfying at least one of the following two conditions, it is determined not to permit assigning the virtual ID to the logical volume 271 and using the logical volume 271 (the storage device 200 other than the usage target storage device can be permitted, step S1603: No), the processing proceeds to step S1605.

(Condition 1) In the virtual ID history table, “latest permitted logical volume deletion record” has not been created since “the latest permitted record.” was created. Here, the “latest permitted record” is the most recently created record among the record whose value of the usage permission information is “permitted (Yes) in the virtual ID history table.

The “latest permitted logical volume” is the logical volume 271 associated with the “latest permitted record”.

The “latest permitted logical volume deletion record” is the record recording the deletion of the “latest permitted logical volume”.

Here, the “latest permitted logical volume deletion record” is the record of a permission stop block in a block chain format, that includes a usage target virtual ID, the storage device ID (hereinafter, referred to as the latest permitted storage device ID) stored in the latest permitted record, usage permission information indicating not permitted (No), and a hash value. If condition 1 is satisfied, only the latest permitted logical volume 271 is allowed to assign the usage target virtual ID and to use.

(Condition 2) The most recently permitted storage device ID and the usage target storage device ID are the same. Note that, in the virtual ID history table, the condition 1 and the condition 2 are considered to be satisfied, even the case where there is no record in which the value of the usage permission information is “permitted (Yes)” and no record other than the record of the initial setting (the record whose the block number 901 is 0) is saved.

In the case where both the condition 1 and the condition 2 are satisfied, and it is determined to permit assigning the virtual ID to the logical volume 271 and using the logical volume 271 (step S1603: Yes), the storage device 200 outputs the consistency determination information indicating “consistency”, and the storage device 200 transmits the usage target virtual ID registration request information as the virtual ID registration request information, to the virtual ID management computer 300, and ends the processing (step S1604).

Here, “consistency” indicates that it is possible to permit using the logical volume with assigned the setting virtual ID. On the other hand, “inconsistency” indicates that it is not possible to permit using the logical volume with assigned the setting virtual ID.

In addition, in step 1604, the storage device 200 generates usage target virtual ID registration request information. The generated usage target virtual ID registration request information includes the usage target virtual ID, the own storage device ID, and the record request information requesting that information about the usage target logical volume to be stored in the virtual ID management record (virtual ID management information) 302.

When the virtual ID management computer 300 receives the usage target virtual ID registration request information, the virtual ID management computer 300 executes (D1) Virtual ID History Table Generation Processing, as described below. In (D1) Virtual ID History Table Generation Processing, the virtual ID management computer 300 generates a permission block in the form of a block chain, including the usage target virtual ID, the usage target storage device ID, the usage permission information indicating “permitted (Yes)”, and a hash value. The virtual ID management computer 300 transmits the generated permission block to a plurality of virtual ID management computers 300. Accordingly, the virtual ID management record 302 that is updated by adding the generated permission block is shared among the plurality of virtual ID management computers 300. Accordingly, a record including the usage target virtual ID, the usage target storage device ID, and the usage permission information indicating “permitted (Yes)”, is additionally stored in the virtual ID management record 302.

As described above, by creating the record including the usage target ID, the usage target storage device ID, and the usage permission information indicating “permitted (Yes)” in the virtual ID management record 302, as described below, it is possible to suppress that each of the plurality of logical volumes 271 of storage devices 200, to be determined to be permitted assigning the same virtual ID and using.

For example, the logical volume 271 is newly created (hereinafter, the created logical volume will be referred to as a creation example logical volume), and (A) Virtual ID Registration Processing (refer to FIG. 13) and (A1) Virtual ID Registration Record Processing are executed, and thus, a record (this record is the latest permitted record) is created in the virtual ID management record 302. This latest permitted record including the usage permission information indicating “permitted (Yes)” to permit assigning the virtual ID (hereinafter, referred to as a creation example virtual ID) to the creation example logical volume and using.

Next, the creation example logical volume is deleted, and (B) Virtual ID Registration Deletion Processing (refer to FIG. 14) and (B1) Virtual ID Registration Deletion Record Processing are executed, and thus, a record is created in the virtual ID management record 302, and the created record is including the usage permission information indicating not to permit assigning the creation example virtual ID to the creation example logical volume and using (No).

At this point, the creation example virtual ID can be permitted to be assigned to any logical volume 271 and to use the logical volume (usage permission information=Yes).

Next, for another logical volume (referred to as creation example2 logical volume), the logical volume usage processing (any of (C) Logical Volume Access Setting Processing, (E) Local Copy Processing in Storage Device, and (F) Remote Copy Processing between Storage Devices) is executed; and in step 1603 of Logical Volume Consistency Determination Processing, the usage target storage device 200 determine to permit assigning the creation example virtual ID to the usage example2 logical volume and using the usage example2 logical volume (the usage permission information=Yes, step 1603: Yes); then the processing of step 1604 is executed.

By the processing of step S1604, a record including the creation example virtual ID and the usage permission information indicating “permitted (Yes)”, is additionally stored in the virtual ID management record 302.

Furthermore, when the logical volume usage processing is executed for another logical volume (referred to as usage example3 logical volume) different from the creation example logical volume assigned with the creation example virtual ID, the Logical Volume Consistency Determination Processing is executed. And in step 1603 of the Logical Volume Consistency Determination Processing, the usage target storage device 200 determine not to permit assigning the creation example virtual ID to the usage example3 logical volume and using the usage example3 logical volume (the usage permission information=No, step 1603: No); then the processing of step 1604 is not executed. In this way, as the processing of step 1604 is not executed, it is possible to suppress that each of the plurality of logical volumes 271 of storage devices 200, to be determined to be permitted assigning the same virtual ID and using.

On the other hand, in in a case where at least one of Condition 1 and Condition 2 is not satisfied, and it is determined not to permit assigning the virtual ID to the logical volume 271 and using the logical volume 271 (step S1603: No), the storage device 200 acquires duplication information that is the information of the logical volume 271 (hereinafter, referred to as a synchronized logical volume 271) synchronized with the logical volume 271 assigned with the usage target virtual ID, with reference to the logical volume management table 207 stored in the own storage device 200 (step S1605). The duplication information is the record storing the usage target virtual ID at the virtual ID 708, in the logical volume management table 207.

Next, the storage device 200 determines whether the usage target virtual ID is the same as the virtual ID (hereinafter, referred to as a synchronized virtual ID) assigned to the synchronized logical volume 271 synchronized with the usage target logical volume, on the basis of the duplication information (step S1606). In a case where it is determined that the usage target virtual ID is the same as the synchronized virtual ID (step S1606: Yes), the processing proceeds to step S1608. On the other hand, in a case where it is determined that the usage target virtual ID is not the same as the synchronized virtual ID (step S1606: No), the processing proceeds to step S1607.

Here, as described above, in one storage device, different virtual IDs are assigned to the logical volumes 271, respectively. Accordingly, in the storage device 200, the virtual ID of the logical volume 271 synchronized with the usage target logical volume, is different from the usage target virtual ID.

In addition, as described above, the duplication information is the record storing the usage target virtual ID at the virtual ID 708, in the logical volume management table 207. In step S1606, specifically, in a case where, in the duplication information, the duplication status is “PAIR”, the duplication type is “Remote”, the copy relations is “dup”, and the virtual ID of a duplication source 705 is the same as the usage target virtual ID, the storage device 200 determines that the usage target virtual ID is the same as the synchronized virtual ID (step S1606: Yes). In addition, in step S1606, in the other case (in a case where the virtual ID of a duplication source 705 is not the same as the usage target virtual ID, in the duplication information (including a case where there is no virtual ID at the virtual ID of a duplication source 705)), the storage device 200 determines that the usage target virtual ID is not the same as the synchronized virtual ID (step S1606: No).

In a case where it is determined that the usage target virtual ID is not the same as the synchronized virtual ID (step S1606: No), the storage device 200 outputs the consistency determination information including “inconsistency”, and ends the processing (step S1607). The processing of step 1607 is executed when it is determined in step 1603 that the usage permission information of the usage target virtual ID is “permitted (Yes)” except for the usage target storage device (step 1603: No), and further when it is determined in step 1606 that the usage target virtual ID is not the same as the synchronized virtual ID (step 1606: No). Therefore, it is not permitted to assign the usage target virtual ID the usage target logical volume and to use the usage target logical volume (usage permission information=No). Further, even in a case where there is the synchronized logical volume 271 that is synchronized with the usage target logical volume and stores the same data as that of the usage target logical volume 271, the synchronized virtual ID thereof is different from the usage target virtual ID. Therefore, in step S1607, the storage device 200 outputs the consistency determination information including “inconsistency” indicating that it is not possible to permit the usage of the logical volume 271 assigned the virtual ID.

On the other hand, in a case where it is determined that the usage target virtual ID is the same as the synchronized virtual ID (step S1606: Yes), the storage device 200 determines whether to permit assigning the virtual ID to the synchronized logical volume 271 and using the synchronized logical volume 271, with reference to the virtual ID history table (step S1608). In a case where it is determined to permit assigning the virtual ID to the synchronized logical volume 271 and using the synchronized logical volume 271, by satisfying both of the following two conditions (step S1608: Yes), the processing proceeds to step S1609. On the other hand, in a case where it is determined not to permit assigning the virtual ID to the synchronized logical volume 271 and using the synchronized logical volume 271, by not satisfying at least one of the following two conditions (step S1608: No), the processing proceeds to step S1610.

In step S1608, a case where it is possible to determine to permit assigning the virtual ID to the synchronized logical volume 271 and using the synchronized logical volume 271, is the case of satisfying both of the following two conditions.

(Condition 3) In the virtual ID history table, “latest permitted logical volume deletion record” has not been created since “the latest permitted record” was created.

(The same with Condition 1 described above. In the case of satisfying Condition 3, only the latest permitted logical volume 271 is permitted to assign the synchronized virtual ID and use)

(Condition 4) The latest permitted storage device ID is different from the usage target storage device ID. Note that, in the virtual ID history table, in a case where there is no record whose the usage permission information is “permission (Yes)”, that is, only the initial setting value (the record whose block number 901 is 0) is stored, Condition 4 is not satisfied.

During synchronizing the logical volumes 271 between storage devices, where the synchronized logical volume 271 is the copy source logical volume 271 and the usage target logical volume 271 is the copy destination logical volume 271, if there is no abnormality, the usage target storage device ID and the synchronizing storage device ID should be different.

Therefore, in a case where there is no abnormality, it is determined in step 1608 to permit assigning the synchronized virtual ID to the synchronized logical volume 271 and using (step 1608: Yes) and in step S1609, “consistency” is output. On the other hand, in a case where there is abnormality, it is determined in step 1608 not to permit assigning the synchronized virtual ID to the synchronized logical volume 271 and using (step 1608: No) and in step S1610, “inconsistency” is output.

In a case where there is no abnormality in step S1608, the storage device 200 outputs the consistency determination information including “consistency”, and ends the processing (step S1609). Accordingly, in a case where the usage target virtual ID is the same as the synchronized virtual ID assigned to the synchronized logical volume 271 that is synchronized with the usage target logical volume 271 (step S1606: Yes), and in the virtual ID management information, the usage permission information (Usage Permission Information=Yes) indicating to permit assigning the virtual ID to the logical volume 271 and using the logical volume 271, is associated with both the synchronized virtual ID, and the synchronized storage device ID of the storage device including the synchronized logical volume 271 (step S1608: Yes), in step S1609, the storage device 200 outputs the consistency determination information including “consistency”. As described below, by outputting the consistency determination information including “consistency” as described above, the logical volume usage processing (Setting the usage target storage device so that the host computer can access the usage target logical volume in Logical Volume Access Setting Processing, local copy in Local Copy Processing in Storage Device, remote copy in Remote Copy Processing between Storage Devices) is executed.

In a case where there is abnormality in step S1608, the storage device 200 outputs the consistency determination information including “inconsistency”, and ends the processing (step S1610).

<(D1) Virtual ID History Table Generation Processing>

When the virtual ID management computer 300 receives the virtual ID history request information containing the usage target virtual ID, the storage device ID of the storage device that transmits the virtual ID history request information, and information indicating to request the virtual ID history table, from the storage device 200 that is executing (D) Logical Volume Consistency Determination Processing (see Step S 1602 in FIG. 15), the virtual ID management unit 301 of the virtual ID management computer 300 executes Virtual ID History Table Generation Processing.

In the Virtual ID History Table Generation Processing, the virtual ID management computer 300 generates the virtual ID history table in which all the blocks (records) storing the usage target virtual ID are extracted from the virtual ID management record 302 and are collected in a table. Then, the virtual ID management computer 300 transmits the generated virtual ID history table to the storage device to which transmitted the virtual ID history request information.

<(D2) Usage Target Virtual ID Record Processing>

When the virtual ID management computer 300 receives the usage target virtual ID registration request information, from the storage device 200 that is executing (D) Logical Volume Consistency Determination Processing (refer to step S1604 in FIG. 15), the virtual ID management unit 301 of the virtual ID management computer 300 executes the Usage Target Virtual ID Record Processing.

In the usage target virtual ID record processing, the virtual ID management computer 300 generates the usage permission information indicating to permit assigning the virtual ID to the logical volume and using the logical volume (Yes).

Next, the virtual ID management computer 300 calculates the hash value by assigning the hash value (the recent hash value) of the recently created block, the usage target virtual ID and the storage device ID which are included in the received usage target virtual ID registration request information, and the generated usage permission information to a predetermined hash function.

Next, the virtual ID management computer 300 generates a permission block including the calculated hash value, the virtual ID and the storage device ID which are included in the received usage target virtual ID registration request information, and the calculated usage permission information.

Next, the virtual ID management computer 300 transmits the generated permission block to a plurality of virtual ID management computers 300, to share the permission block. And the virtual ID management computer 300 updates the virtual ID management record 302 (virtual ID management information) with using the generated permission block.

<(E) Local Copy Processing in Storage Device, FIG. 17>

FIG. 17 is a flowchart illustrating an example of the local copy processing in the storage device of Example. In the case of performing the local copy of the logical volume 271 in the storage device (hereinafter, referred to as the local copy), the logical volume 271 of the copy source and the logical volume 271 of the copy destination are created, and then, the local copy is execute. When a user inputs the information (logical volume identifying information) for identifying the logical volume 271 of the copy source and the information (logical volume identifying information) for identifying the logical volume 271 of the copy destination, to execute the local copy, the logical volume usage processing unit 206 of the storage device 200 calculates the virtual ID (referred to as a copy source virtual ID) assigned to the logical volume 271 of the copy source, with reference to the logical volume management table 207, and executes the Local Copy Processing in Storage Device.

The storage device 200 executes the logical Volume Consistency Determination Processing (refer to FIG. 16) by using the copy source virtual ID and the own storage device ID as input, and acquires the consistency determination information (step S1701). As described above, the consistency determination information includes the information indicating either “consistency” or “inconsistency”.

Next, the storage device 200 determines whether the consistency determination information indicates “consistency” (step S1702).

In a case where it is determined that the consistency determination information indicates “consistency” (step S1702: Yes), the storage device 200 performs the local copy, and ends the processing (step S1703).

On the other hand, in a case where it is determined that the consistency determination information indicates “inconsistency” but not “consistency” (step S1702: No), the storage device 200 presents that it is not possible to execute the local copy (“Cannot permit assigning the virtual ID to the logical volume 271 and using the logical volume 271”), and ends the processing (step S1704). Here, the presentation of “Cannot permit assigning the virtual ID to the logical volume 271 and using the logical volume 271” may be presented to the user by, for example, the storage device 200 outputting to display an image with characters or symbols representing “The local copy of the logical volume 271 of the copy source is inhibited due to the Inconsistency.”, or may be presented to the user by voice.

<(F) Remote Copy Processing Between Storage Devices>

FIG. 18 is a flowchart illustrating an example of the remote copy processing between the storage devices of Example. In the case of performing the remote copy of the logical volume 271 between the storage devices (hereinafter, referred to as the remote copy), the logical volume 271 of the copy source and the logical volume 271 of the copy destination are created, and then, the remote copy is executed.

To execute the local copy, a user inputs the information (logical volume identifying information) for identifying the logical volume 271 of the copy source, the information for identifying the storage device including the logical volume 271 of the copy source, the information (logical volume identifying information) for identifying the logical volume 271 of the copy destination, and the information for identifying the storage device including the logical volume 271 of the copy destination, to an arbitrary storage device 200.

Accordingly, the logical volume usage processing unit 206 of the storage device 200 generates remote copy start information including, in addition to the input information above, information indicating that remote copy is to be executed. Then, the storage device 200 transmits the remote copy start information to the storage device including the logical volume 271 of the copy source and the storage device including the logical volume 271 of the copy destination. When the storage device 200 receives the remote copy start information, the logical volume usage processing unit 206 of the storage device 200 executes Remote Copy Processing between Storage Devices.

The storage device 200 that receives the remote copy start information determines whether the own storage device is the storage device including the logical volume 271 of the copy source, based on the information for identifying the storage device including the logical volume 271 of the copy source, which is included in the remote copy start information (step S1801). In a case where it is determined that the own storage device is the storage device (a copy source storage device) including the logical volume 271 of the copy source (step S1801: Yes), the processing proceeds to step S1802. On the other hand, in a case where it is determined that the own storage device is the storage device (a copy destination storage device) including the logical volume 271 of the copy destination but not the storage device including the logical volume 271 of the copy source (step S1801: No), the processing proceeds to step S1804, and the remote copy is executed. Here, the execution of the remote copy means that when the copy destination storage device receives the data to be copied of the logical volume 271 of the copy source, the data to be copied of the logical volume 271 of the copy source is set to be copied to the logical volume of the copy destination. This enables the copy destination storage device to execute the copy as soon as it receives the data to be copied.

The copy source storage device 200 calculates the virtual ID (hereinafter, referred to as a copy source virtual ID) assigned to the logical volume 271 of the copy source, based on the remote copy start information and the logical volume management table 207, executes the Logical Volume Consistency Determination Processing with the copy source virtual ID and the own storage device ID as input, and acquires the consistency determination information (step S1802). As described above, the consistency determination information includes the information indicating either “consistency” or “inconsistency”.

Next, the storage device 200 determines whether the consistency determination information indicates “consistency” (step S1803).

In a case where it is determined that the consistency determination information indicates “consistency” (step S1803: Yes), the copy source storage device 200 performs the remote copy, and ends the processing (step S1804).

On the other hand, in a case where it is determined that the consistency determination information indicates “inconsistency” but not “consistency” (step S1803: No), the copy source storage device 200 presents that it is not possible to execute the remote copy (“Cannot permit assigning the virtual ID to the logical volume 271 and using the logical volume 271”), and ends the processing (step S1805). Here, the presentation of “Cannot permit assigning the virtual ID to the logical volume 271 and using the logical volume 271” may be presented to the user by, for example, the storage device 200 outputting to display an image with characters or symbols representing “The remote copy of the logical volume 271 of the copy source is inhibited due to the ‘inconsistency’.”, or may be presented to the user by voice.

Hereinafter, the details of the processing that is executed by the virtual ID management unit 301 of the virtual ID management computer 300 will be described. Note that, the block generated by the virtual ID management computer 300 includes the permission block and the permission stop block. The permission block indicates that the usage permission information included in the permission block is permitted (Yes). On the other hand, the permission stop block indicates that the usage permission information included in the permission stop block is not permitted (No).

### Effects of Invention

As described above, in Example, the storage system 1 determines whether to permit assigning the virtual ID to the logical volume and using the logical volume by using the virtual ID management record 302 (the virtual ID management information). Then, in the case where it is determined not to permit assigning the virtual ID to the logical volume and using the logical volume, the storage system 1 does not execute the logical volume usage processing which use the usage target logical volume.

Accordingly, the storage system 1 can prevent the destruction of data stored in logical volumes that occurs when the same ID for identifying the logical volumes is assigned to each of a plurality of logical volumes in which different data are stored.

In addition, as described above with reference to FIG. 1, the storage device 200 can be placed in a variety of locations depending on the organization of a user using the storage device 200, for example, a company or the like. For example, there are cases where storage devices 200 are arranged over a wide area, such as a case where storage devices 200 are arranged in each of a plurality of countries. In addition, there are cases where a host computer 100a1 to 100an may create and use new logical volumes not only in the storage device 100a1 to 100an used by the host computer 100a1 to 100an but also in the storage device 100b1 to 100bn used by other host computers 200b1 to 200bn. In addition, the storage device 200, which has been placed and used in various places, may be connected to and used by a host computer 100 that has not been connected before due to a change in the organization to which the user of the storage device 200 belongs. Even in such a case, the storage system 1 prevents the destruction of data stored in logical volumes that occurs when the same ID for identifying the logical volumes is assigned to each of a plurality of logical volumes in which different data are stored.

Further, the storage system 1 can reduce the burden on the administrator of the storage device 200 to manage the virtual ID. The storage system 1 can prevent necessary data from being accidentally deleted in the virtual storage environment, and can prevent business suspension and deterioration of trust due to data destruction. Further, the storage system 1 can reduce the energy required to share data and the amount of carbon dioxide emissions generated, thereby suppressing global warming.

In addition, the virtual ID management record 302 (the virtual ID management information) is managed in the form of a block chain. Accordingly, the storage system 1 can suppress falsification of the virtual ID management record 302 (the virtual ID management information).

In addition, in a case where the logical volume is created (refer to the flowchart of the virtual ID registration processing in FIG. 13), in a case where the logical volume is deleted (refer to the flowchart of the virtual ID registration deletion processing in FIG. 14), and in a case where it is determined to permit assigning the virtual ID to the logical volume and using the logical volume (refer to the flowchart of the logical volume consistency determination processing in FIG. 16), the storage system 1 generates the permission block or the permission stop block. Accordingly, the virtual ID management record 302 (the virtual ID management information) is suitably generated.

In addition, in the following two cases, the storage system 1 determines to permit assigning the virtual ID to the logical volume and using the logical volume.

(1) A case where in the virtual ID management record 302 (virtual ID management information), the usage target virtual ID and all the storage device IDs other than the usage target storage device ID are not associated with the usage permission information indicating to permit assigning the virtual ID to the logical volume and using the logical volume (step S1604 of the flowchart of the logical volume consistency determination processing in FIG. 16).

(2) A case where the usage target virtual ID is the same as the synchronized virtual ID assigned to the synchronized logical volume that is synchronized with the usage target logical volume, and in the virtual ID management information, the usage permission information indicating to permit assigning the virtual ID to the logical volume and using the logical volume, is associated with the synchronized virtual ID, and the synchronizing storage device ID of the storage device including synchronized logical volume (step S1609 of the flowchart of the logical volume consistency determination processing in FIG. 16). Accordingly, the storage system 1 can more reliably prevent the destruction of data stored in logical volumes that occurs when the same ID for identifying the logical volumes is assigned to each of a plurality of logical volumes in which different data are stored.

In addition, in Example, one of the logical volume usage processing which use the usage target logical volume, is the processing of setting the storage device so that the host computer can access the usage target logical volume (refer to the flowchart of the logical volume access setting processing in FIG. 15). Accordingly, by setting the storage device so that the host computer can access the usage target logical volume, it is possible more reliably to prevent the destruction of data stored in logical volumes 271.

In addition, in Example, one of the logical volume usage processing which use the usage target logical volume, is the local copy processing of creating the copy of the logical volume in the storage device (refer to the flowchart of the local copy processing in the storage device in FIG. 17). Accordingly, in the local copy processing, it is possible more reliably to prevent the destruction of data stored in logical volumes 271.

In addition, in Example, one of the logical volume usage processing which use the usage target logical volume, is the remote copy processing of creating the copy of the logical volume between the storage devices (refer to the flowchart of the remote copy processing between the storage devices in FIG. 18). Accordingly, in the remote copy processing, it is possible more reliably to prevent the destruction of data stored in logical volumes 271.

In addition, the storage system 1 outputs the information indicating not to permit assigning the virtual ID to the logical volume and using the logical volume (refer to step S1504 of the logical volume access setting processing in FIG. 15, step S1704 of the local copy processing in the storage device in FIG. 17, and step S1805 of the remote copy processing between the storage devices in FIG. 18). Accordingly, the user of the storage device 200 can easily know whether the logical volume 271 which the user attempt to use is the logical volume set to permit assigning the virtual ID to the logical volume 271 and using the logical volume 271.

### Modification Example

In the storage system 1 of Example, when the logical volume is created, the block is generated, and the virtual ID management record 302 in the form of a block chain, is updated (refer to step S1301 of the flowchart of the virtual ID registration processing in FIG. 13). In a Modification Example, when the logical volume is created, the block is not generated and the virtual ID management record (virtual ID management information) 302 in the form of a block chain is not updated.

Specifically, the storage system 1 of the Modification Example does not execute (A) Virtual ID Registration Processing (refer to FIG. 13) and (A1) Virtual ID Registration Record Processing. On the other hand, as with the storage system 1 of Example, the storage system 1 of the Modification Example executes (B) Virtual ID Registration Deletion Processing (refer to FIG. 14), (B1) Virtual ID Registration Deletion Record Processing, (C) Logical Volume Access Setting Processing (refer to FIG. 15), (D) Logical Volume Consistency Determination Processing (refer to FIG. 16), (D1) Virtual ID History Table Generation Processing, (D2) Usage Target Virtual ID Record Processing, (E) Local Copy Processing in Storage Device (refer to FIG. 17), and (F) Remote Copy Processing between Storage Devices (refer to FIG. 18).

Accordingly, the permission block is generated when an attempt is made to use a logical volume (refer to step S1604 of the flowchart of (D) Logical Volume Consistency Determination Processing in FIG. 16). Specifically, the storage device 200 execute logical volume usage processing ((C) Logical Volume Access Setting Processing, (E) Local Copy Processing in Storage Device, and (F) Remote Copy Processing between Storage Devices) which use the usage target logical volume as the usage target; storage device 200 execute (D) Logical Volume Consistency Determination Processing, and when executing the processing of step S1604 of the flowchart of (D) Logical Volume Consistency Determination Processing, the storage device 200 generates a permission block and updates the virtual ID management record (virtual ID management information) 302 in the form of a block chain.

On the other hand, when the logical volume is deleted, the storage device 200 generates the permission stop block by executing (B) Virtual ID Registration Deletion Processing (FIG. 14) and (B1) Virtual ID Registration Deletion Record Processing.

As described above, when the logical volume is created, the storage system 1 of Modification Example does not generate the permission block. Accordingly, it is possible to further decrease the size of the data of the virtual ID management record 302.

In addition, the permission block of the logical volume that is a target of the logical volume usage processing ((C) Logical Volume Access Setting Processing, (E) Local Copy Processing in Storage Device, and (F) Remote Copy Processing between Storage Devices) is generated. Therefore, a virtual ID which has not been assigned to a logical volume that is a subject of logical volume usage processing, can be assigned to a logical volume which is the subjected of logical volume usage processing, and the logical volume which is the subjected of logical volume usage processing can be used.

What is claimed is:

1. A storage system including a plurality of storage devices connected to a host computer, wherein a logical volume for storing information is created in each of the storage devices, a virtual ID for identifying the logical volume is assigned to the logical volume, and the virtual ID is used to identify the logical volume to be accessed by the host computer, the storage system comprising:
a memory unit configured to store virtual ID management information which stores in association with each other, the virtual ID, a storage device ID identifying the storage device including the logical volume assigned to the virtual ID, and usage permission information indicating whether to permit assigning the virtual ID to the logical volume and using the logical volume;
a logical volume usage processing unit configured
to identify a usage target virtual ID assigned to the usage target logical volume, and the usage target storage device ID of the usage target storage device including the usage target logical volume, when a logical volume identifying information for identifying a usage target logical volume which is target of use is input, and
to determine whether to permit assigning the virtual ID to the logical volume and using the logical volume, based on consistency with the virtual ID management information,
In the case where it is determined to permit assigning the virtual ID to the logical volume and using the logical volume, the logical volume usage processing unit execute the logical volume usage processing which use the usage target logical volume, and
In the case where it is determined not to permit assigning the virtual ID to the logical volume and using the logical volume, the logical volume usage processing unit does not execute the logical volume usage processing which use the usage target logical volume.

2. The storage system according to claim 1,
further comprising a plurality of virtual ID management computers connected to the plurality of storage devices,
wherein the storage device comprises the logical volume usage processing unit,
wherein the logical volume usage processing unit configured to transmit a virtual ID registration request information including the virtual ID, the storage device ID of own, and record request information indicating to store a record in the virtual ID management information, to at least one of the plurality of virtual ID management computers;
each of the plurality of virtual ID management computers comprises the memory unit, and a virtual ID management unit;
the memory unit configured to store the virtual ID management information in the form of a block chain including at least one block, and
the virtual ID management unit configured
to generate the usage permission information, based on the received virtual ID registration request information, when the virtual ID registration request information is received from the storage device,
to calculate a hash value by substituting the most recent hash value of the most recently created block, the virtual Id and the storage device ID included in the received virtual ID registration request information, and the generated usage permission information into a predetermined hash function,
to generate a block including the calculated hash value, the virtual ID and the storage device ID included in the received virtual ID registration request information, and the generated usage permission information,
to share the generated block with the plurality of virtual ID management computers,
to update the virtual ID management information with using the generated block, and
to update the virtual ID management information with using the received block, when the block is received from the virtual ID management computer different from the virtual ID management computer itself.

3. The storage system according to claim 2,
wherein the logical volume usage processing unit of the storage device transmit a virtual ID registration request information to at least one of the plurality of virtual ID management computers, in the case of creating the logical volume, in the case of deleting the logical volume, and in the case that the logical volume usage processing unit determined to permit assigning the virtual ID to the logical volume and using the logical volume.

4. The storage system according to claim 1,
Wherein the logical volume usage processing unit determine to permit assigning the virtual ID to the logical volume and using the logical volume,
In the case where the virtual ID management information stores the usage target virtual ID and the usage target storage device ID that are associated with the usage permission information indicating to permit assigning the virtual ID to the logical volume and using the logical volume, or
In the case where the virtual ID management information stores the usage target virtual ID and the usage target storage device ID that are not associated with the usage permission information indicating to permit assigning the virtual ID to the logical volume and using the logical volume;
the usage target virtual ID is the same as the synchronized virtual ID assigned to the synchronized logical volume that is synchronizing with the usage target logical volume; and
the virtual ID management information stores the synchronized virtual ID and the synchronizing storage device ID of the storage device including the synchronized logical volume that are associated with the usage permission information indicating to permit assigning the virtual ID to the logical volume and using the logical volume.

5. The storage system according to claim 1,
wherein the logical volume usage processing using the usage target logical volume is the processing that set the storage device so that the host computer can access the usage target logical volume.

6. The storage system according to claim 1,
wherein the logical volume usage processing using the usage target logical volume is the processing that create a copy of the logical volume in the storage device.

7. The storage system according to claim 1,
wherein the logical volume usage processing using the usage target logical volume is the processing that create a copy of the logical volume between the storage devices.

8. The storage system according to claim 1,
wherein In the case where the logical volume usage processing unit determine not to permit assigning the virtual ID to the logical volume and using the logical volume, the logical volume usage processing unit outputs the information indicating not to permit assigning the virtual ID to the logical volume and using the logical volume.

9. A data management method of a storage system including a plurality of storage devices connected to a host computer, wherein each of the storage devices including a storage device and a processor, a logical volume for storing information is created in each of the storage devices, a virtual ID for identifying the logical volume is assigned to the logical volume, and the virtual ID is used to identify the logical volume to be accessed by the host computer,
the storage devices store virtual ID management information which stores in association with each other, the virtual ID, a storage device ID identifying the storage device including the logical volume assigned to the virtual ID, and usage permission information indicating whether to permit assigning the virtual ID to the logical volume and using the logical volume; the method comprising: by the processor,
identifying a usage target virtual ID assigned to the usage target logical volume, and the usage target storage device ID of the usage target storage device including the usage target logical volume, In the case where a logical volume identifying information for identifying a usage target logical volume which is target of use is input; and
determining whether to permit assigning the virtual ID to the logical volume and using the logical volume, based on consistency with the virtual ID management information,
In the case where it is determined to permit assigning the virtual ID to the logical volume and using the logical volume, the processor execute the logical volume usage processing which use the usage target logical volume; and
In the case where it is determined not to permit assigning the virtual ID to the logical volume and using the logical volume, the processor does not execute the logical volume usage processing which use the usage target logical volume.
